(19) United States
(12) Patent Application Publication
(10) Pub. No.: US 2020/0231494 A1
(43) Pub. Date: Jul. 23, 2020

(54) DOUBLE-SIDED GLASS

(71) Applicant: Zhejiang Yotrio Group Co., Ltd., Linhai City (CN)

(72) Inventors: Hongjie Zheng, Linhai City (CN); Jianqiang Xie, Linhai City (CN)

(73) Assignee: Zhejiang Yotrio Group Co., Ltd., Linhai City (CN)

(21) Appl. No.: 16/712,417

(22) Filed: Dec. 12, 2019

(30) Foreign Application Priority Data
Jan. 23, 2019 (CN) 201920115749.9

(51) Int. Cl. C03C 17/34; C03C 17/00

(52) U.S. Cl. CPC C03C 17/34; C03C 2218/119; C03C 2217/72; C03C 17/002

(57) ABSTRACT

This invention provides a double-sided glass, and relates to a technical field of glass. The double-sided glass includes a glass body, a first color layer, and a second color layer. The first color layer and the second color layer are both disposed at a same side of the glass body. By arranging the first color layer and the second color layer on the same side of the glass body, the glass body does not need to be flipped during manufacturing, which greatly reduces the production difficulty and improves the production effectiveness. Secondly, since the first color layer and the second color layer are disposed on a same side, it is not necessary to seal surrounding edges of the glass body.

### CROSS-REFERENCE TO RELATED APPLICATIONS

This Non-provisional application claims the benefit of priority under 35 U.S.C. § 119(a) on Chinese Patent Application No(s). 201920115749.9 filed on 23 Jan. 2019, the disclosure of which is hereby incorporated by reference in its entirety.

### BACKGROUND OF THE INVENTION

### Field of the Invention

This invention relates to a technical field of glass, and more particularly, to a double-sided glass.

### Description of the Related Art

Glass is widely used in furniture. There are many kinds of glass with paints or other materials on the market, and it is used in the furniture industry by various fixing methods such as uppering, embedding or covering.

The double-sided glass with patterns on the market, whether by painting or by attaching other materials, is separately provided with a pattern or a color on both sides of a glass body to create double-sided color effect. However, this way of being disposed on both sides of the glass body requires a turning operation during production, which is not conducive to production. At the same time, the colored layer is extremely susceptible to scratching of the hard metal when used, which makes the glass surface damaged, and the product lose its integrity and use value.

### BRIEF SUMMARY OF THE INVENTION

In order to overcome at least one deficiency of the prior art, this invention provides a double-sided glass, solving the problem that the colored layer in the prior art is easy to be damaged, and making it convenient for production and manufacture.

The technical scheme of the utility model is as follows: a double-sided glass includes a glass body, a first color layer, and a second color layer. The first color layer and the second color layer are both disposed at a same side of the glass body.

Further, the first color layer may be disposed between the glass body and the second color layer.

Further, the double-sided glass may also include a back cover layer, and the back cover layer may be disposed between the first color layer and the second color layer.

Further, the back cover layer may be a water paint layer or an oil paint layer.

Further, the double-sided glass may also include a sandblasting layer, and the sandblasting layer may be disposed between the back cover layer and the second color layer.

Further, the first color layer may be a print layer or a screen printing layer. Further, the second color layer may be a paint layer. Further, the second color layer may be an overlay paint layer or a self-drying paint layer or an inject paint layer.

The beneficial effects of the utility model are: By arranging the first color layer and the second color layer on the same side of the glass body, the glass body does not need to be flipped during manufacturing, which greatly reduces the production difficulty and improves the production effectiveness. Secondly, since the first color layer and the second color layer are disposed on a same side, it is not necessary to seal surrounding edges of the glass body, which not only solves the problem of poor adhesion of edge sealing, but also solves the problem of expensive price of edge sealing. When using, the glass body can be disposed toward the outside environment, so that the first color layer and the second color layer are both protected by the glass body, thereby greatly reducing the possibility of damage to the colored layer, to improve the service life of the product.

### BRIEF DESCRIPTION OF THE DRAWINGS

FIG. 1 is a distribution diagram of materials of each layer in embodiment One of this utility model.

The reference numerals in the figure are: 1, glass body; 2, first color layer; 3, second color layer; 4, back cover layer; 5, sandblasting layer.

### DETAILED DESCRIPTION OF THE INVENTION

Following is a detailed description of the utility model in conjunction with the drawings.

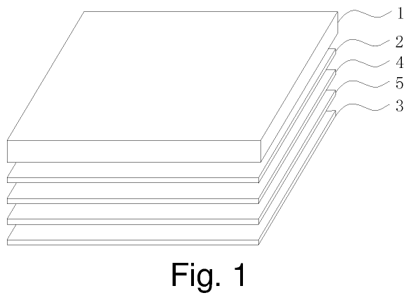

Please refer to FIG. 1, the embodiment of this invention provides a double-sided glass, including a glass body 1, a first color layer 2, and a second color layer 3. The first color layer 2 and the second color layer 3 are both disposed at a same side of the glass body 1.

By arranging the first color layer 2 and the second color layer 3 on the same side of the glass body 1, the glass body 1 does not need to be flipped during manufacturing, which greatly reduces the production difficulty and improves the production effectiveness.

Secondly, since the first color layer 2 and the second color layer 3 are disposed on the same side, it is not necessary to seal surrounding edges of the glass body 1, which not only solves the problem of poor adhesion of edge sealing, but also solves the problem of expensive price of edge sealing.

When using, the glass body 1 can be disposed toward the outside environment, so that the first color layer 2 and the second color layer 3 are both protected by the glass body 1, thereby greatly reducing the possibility of damage to the colored layer, to improve the service life of the product.

The first color layer 2 is a print layer or a screen printing layer. The second color layer 3 is a paint layer, and the second color layer 3 can be an overlay paint layer or a self-drying paint layer or an inject paint layer.

In this embodiment, the first color layer 2 can be the print layer, and the print layer is printed by an UV ink printer. The second color layer 3 is the overlay paint layer, and the overlay paint layer is made of PU fluorocarbon paint.

In this embodiment, the double-sided glass also includes a back cover layer 4 and a sandblasting layer 5.

The first color layer 2 is disposed between the glass body 1 and the second color layer 3, the back cover layer 4 is disposed between the first color layer 2 and the second color layer 3, and the sandblasting layer 5 is disposed between the back cover layer 4 and the second color layer 3. That is, the order of the layers is as follows: the glass body 1, the first color layer 2, the back cover layer 4, the sandblasting layer 5 and the second color layer 3 in turn.

A thickness of the first color layer 2 is larger than that of the second color layer 3. A transmissivity of the first color layer 2 is smaller than that of the second color layer 3, making sure the light can flow smoothly into the first color layer 2. The first color layer and the second color layer may also be provided in a hollow space, which has a thermal insulation effect. Or in other embodiments, the first color layer may also be wrapped inside the second color layer, that is, a second color layer is provided on both sides of the first color layer. In this way, no matter which side of the glass is viewed, the second color layer is displayed first, and then the first color layer is displayed to ensure the consistency of the color when viewed from both sides.

The back cover layer 4 is a water paint layer or an oil paint layer. In this embodiment, the back cover layer 4 is the oil paint layer. Such arrangement of the sealing layer 4 not only seals a portion of the print layer that may be missed, but also effectively promotes the combination of the sandblasting layer 5 and the print layer to make two different materials completely integrated. The arrangement of the sandblasting layer 5 makes the overlay paint layer more firmly adherent, so that materials made of four layers are effectively attached to the glass body 1 to show a new double-sided glass, bringing a new optional material for the furniture industry.

The above mentioned is only the preferred embodiment of the utility model, which does not restrict the patent protection scope of the utility model. Any equivalent structural transformation made by using the contents of the instruction and the drawings of the utility model, directly or indirectly applied in other related technical fields, is equally included in the protection scope of the utility model.

What is claimed is:

1. A glass body, wherein comprises a glass body, a first color layer, and a second color layer, the first color layer and the second color layer are both disposed at a same side of the glass body.

2. The double-sided glass according to claim 1, wherein the first color layer is disposed between the glass body and the second color layer.

3. The double-sided glass according to claim 2, wherein the double-sided glass further comprises a back cover layer, and the back cover layer is disposed between the first color layer and the second color layer.

4. The double-sided glass according to claim 2, wherein the back cover layer is a water paint layer or an oil paint layer.

5. The double-sided glass according to claim 1, wherein the double-sided glass further comprises a sandblasting layer, and the sandblasting layer is disposed between the back cover layer and the second color layer.

6. The double-sided glass according to claim 1, wherein the first color layer is a print layer or a screen printing layer.

7. The double-sided glass according to claim 5, wherein the second color layer is a paint layer.

8. The double-sided glass according to claim 6, wherein the second color layer is an overlay paint layer or a self-drying paint layer or an inject paint layer.

9. The double-sided glass according to claim 2, wherein the double-sided glass further comprises a sandblasting layer, and the sandblasting layer is disposed between the back cover layer and the second color layer.

10. The double-sided glass according to claim 3, wherein the double-sided glass further comprises a sandblasting layer, and the sandblasting layer is disposed between the back cover layer and the second color layer.

11. The double-sided glass according to claim 4, wherein the double-sided glass further comprises a sandblasting layer, and the sandblasting layer is disposed between the back cover layer and the second color layer.
